(19) United States
(12) Patent Application Publication
(10) Pub. No.: US 2005/0053509 A1
(43) Pub. Date: Mar. 10, 2005

(54) Hinged-vane rotary pump

(76) Inventor: Curtis J. Liposcak, Madison, WI (US)

Correspondence Address: Joseph T. Leone;DeWitt Ross & Stevens S.C., 8000 Excelsior Drive, Madison, WI, 53737, US

(21) Appl. No.: 10/932,770

(22) Filed: Sep. 2, 2004

Related U.S. Application Data
(60) Provisional application No. 60/500,059, filed on Sep. 4, 2003.

(51) Int. Cl. F03C 2/00

(52) U.S. Cl. 418/268

(57) ABSTRACT

A hinged-vane rotary pump is disclosed. The pump includes a rotor eccentrically disposed within a chamber and having attached thereto at least two vanes movable between a retracted position and an extended position. At least one friction reducer is attached to each vane, wherein the friction reducer contacts the wall of the chamber when its corresponding vane is in the extended position, and also prevents the second end of its corresponding vane from contacting the peripheral wall when the corresponding vane is in the extended position.

### CROSS-REFERENCE TO RELATED APPLICATIONS

Priority is hereby claimed to provisional application Ser. No. 60/500,059, filed Sep. 4, 2003, the entire content of which is incorporated herein by reference.

### FIELD OF THE INVENTION

The invention is directed to a hinged-vane, eccentric-rotor pump, whose intended use is as a supercharger for internal combustion engines. The pump, however, is equally suitable for moving any compressible or non-compressible liquid.

### BACKGROUND

Rotary pumps are known in the art, as are hinged-vane rotary pumps. See, for example, U.S. Pat. No. 5,816,789, issued Oct. 6, 1998, to Johnson; U.S. Pat. No. 5,697,773, issued Dec. 16, 1997, to Mendoza et al.; U.S. Pat. No. 5,571,005, issued Nov. 5, 1996, to Stoll et al.; U.S. Pat. No. 5,090,501, issued Feb. 25, 1992, to McNulty; U.S. Pat. No. 5,051,059, issued Sep. 24, 1991, to Rademacher; and U.S. Pat. No. 4,069,669, issued Jan. 24, 1978, to Pitkanen. All of these pumps suffer from certain drawbacks, the most notable of which is that they require lubrication. For example, in the case of the Stoll et al. device, because the vanes contact the inside surface of the pump house, the vanes require lubrication (or they must be replaced periodically as their leading edges degrade).

Additionally, the prior art describes hinged-vane pumps wherein the hinge point is not at an end of the vane, but rather in the middle. The Stoll et al. patent describes an exemplary device. See also the Rademacher patent. The Rademacher device is not drawn to a pump so much as a turbine for generating rotational motion from flowing water. Thus, the Rademacher device is more akin to a water-wheel than to a pump. Water flows toward the leading edge of each vane, thereby extending the vane and moving a central rotor due to the force of the water impinging upon the vane. In the Rademacher device, as in the other pumps described in the prior art, the vanes contact the pump housing directly, thereby shortening the useful life of the pump between required maintenance.

Also, the prior art pumps are not suitable for use as superchargers for internal combustion engines because lubrication for the pump is vented from the exhaust end of the pump. When being used as a supercharger this lubrication would be vented directly into the intake manifold of the engine. This fouls the spark plugs specifically and the piston chambers in general. What is required under these circumstances is a pump that moves air cleanly and under pressure to the intake manifold of an engine.

### SUMMARY OF THE INVENTION

The invention is directed to a rotary pump. The pump comprises a housing defining an internal chamber, wherein the internal chamber has a peripheral wall. A rotor is eccentrically positioned within the internal chamber. At least two vanes, each vane having a first end and a second end, are pivotally mounted to the rotor by the first end of each vane. Each of the vanes is movable between a retracted position and an extended position. At least one friction reducer (e.g., a ball bearing, roller bearing, bushing, and the like) is attached to the second end of each rotor. The friction reducer is dimensioned and configured to contact the peripheral wall of the internal chamber when its corresponding vane is in the extended position, and also to prevent the second end of its corresponding vane from contacting the peripheral wall when the corresponding vane is in the extended position. In this fashion, only the friction reducer contacts the peripheral wall of the chamber and the pump can be operated without the need for internal lubrication.

In a preferred embodiment, the rotor defines a corresponding complementary pocket for each friction reducer. Here, each complementary pocket is positioned within the rotor such that its corresponding friction reducer rests within the corresponding complementary pocket when the vane to which the friction reducer is attached is in the retracted position. It is also preferred that when each vane is in the extended position, a gap of from about 1 mil to about 10 mils (about 0.0025 mm to about 0.25 mm) is defined between the second end of each vane and the peripheral wall of the internal chamber.

The rotary pump may also optionally include a bearing race defined concentrically within, and with respect to, the peripheral wall of the internal chamber. When the bearing race is included in the pump, each friction reducer is then dimensioned and configured to engage, and to travel within, the bearing race.

### BRIEF DESCRIPTION OF THE DRAWINGS

FIGS. 1-6 are a series of transverse cross-sectional views of a first embodiment of an eccentric-rotor pump according to the present invention in various stages of rotation. FIG. 1 depicts the rotor 18 at an arbitrary 0° position. FIGS. 2, 3, 4, 5, and 6 depict the rotor as it moves (in a clock-wise rotation) through 15°, 30°, 45°, 60°, and 75° of rotation relative to the position depicted in FIG. 1.

FIG. 7 is a longitudinal cross-sectional view of a second embodiment of an eccentric-rotor pump according to the present invention.

FIG. 8 is a transverse cross-sectional view of the second embodiment of the invention as illustrated in FIG. 7 showing the concentric bearing race 30, along with the eccentric path followed by the first end of each vane (broken line 34) and the concentric path followed by the second end of each vane (solid line 32).

FIG. 9 is a simplified transverse cross-sectional view of the second embodiment as illustrated in FIG. 7, with the rotor and vanes removed. FIG. 9 illustrates the concentric bearing race 30, the concentric path followed by the second end of each vane (32) and a portion 34′ of the eccentric path followed by the first end of each vane.

FIG. 10 is a is a longitudinal cross-sectional view of the end (40) of the housing of the pump, illustrating the mounting flange 42 and the shoulder 30′ that (in cooperation with the pump housing itself) defines the concentric bearing race 30.

### DETAILED DESCRIPTION OF THE INVENTION

The invention is directed to a hinged-vane rotary pump. The pump comprises a housing defining a chamber. A rotor is eccentrically positioned within the chamber. Pivotally mounted to the rotor are a plurality of vanes, each vane being movable between a retracted position and an extended position. Each vane has a first end and a second end. The first end of each vane is pivotally mounted to the rotor. The second end of each vane includes at least one friction reducer, such as a bearing or bushing, mounted thereto. The friction reducer is dimensioned and configured so as to prevent the second end of the vane to which it is attached from contacting the housing when the vane is in the extended position. A bearing is the preferred friction reducer, so in the discussion that follows, the term “bearing” shall be used exclusively. This is for purposes of brevity only. Each bearing is mounted to the second end of its corresponding vane so that it (the bearing) can freely rotate along the chamber wall. In the preferred embodiment, the rotor defines a plurality of cavities corresponding to the number of bearings, each cavity being complementary to the dimensions of the bearings so as to accommodate each bearing when its corresponding vane is in the retracted position.

In one embodiment of the invention, the chamber includes a concentrically-disposed bearing race defined in the chamber wall. In this embodiment of the invention, the bearings mounted at the second end of each vane matingly engage the concentric bearing race and are forced by the bearing race to follow the contour of the wall of the chamber. In this fashion, when the eccentric-rotor is rotated, the first end of each vane follows the eccentric path of the rotor (i.e., eccentric in relation to the chamber wall), while the second end of each vane follows the concentric path of the bearing race (i.e., concentric in relation to the chamber wall).

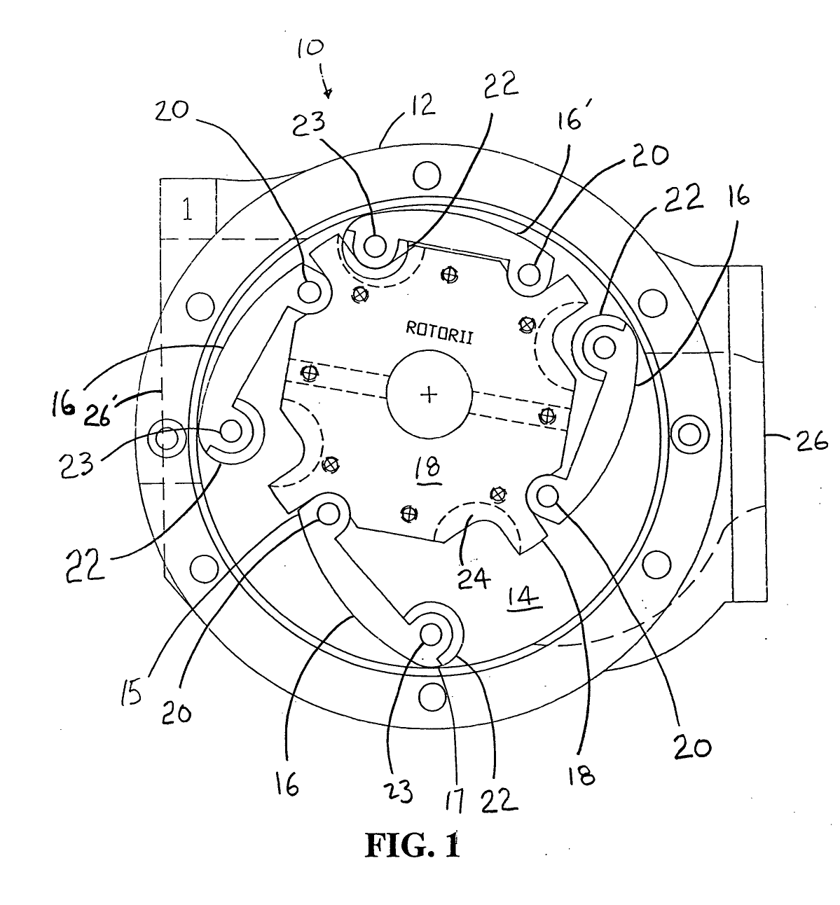

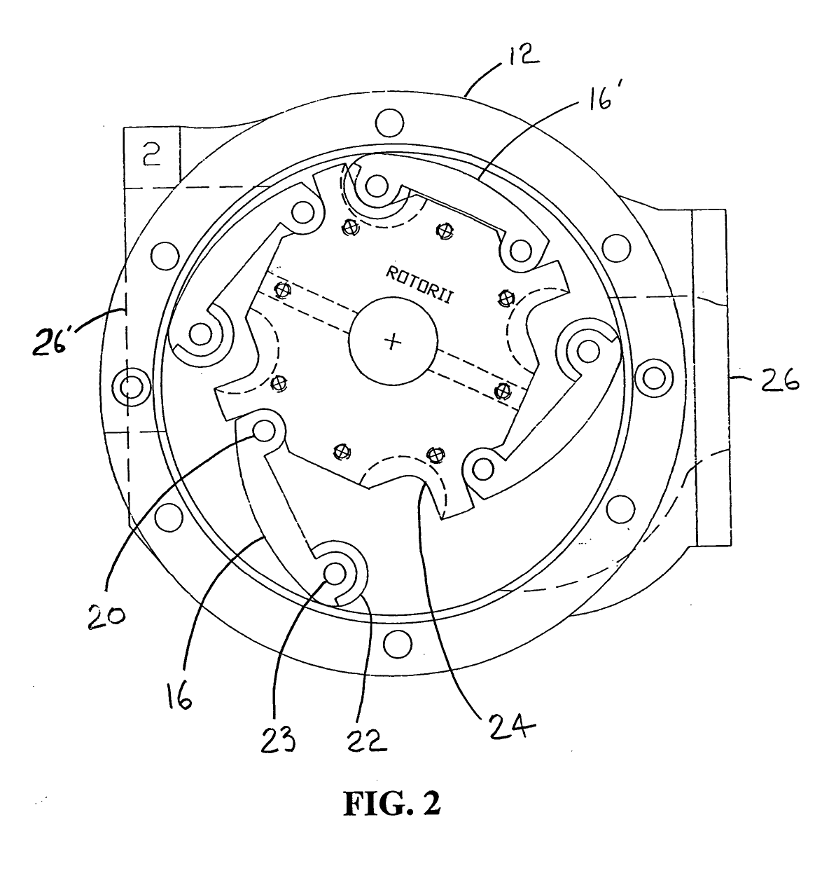

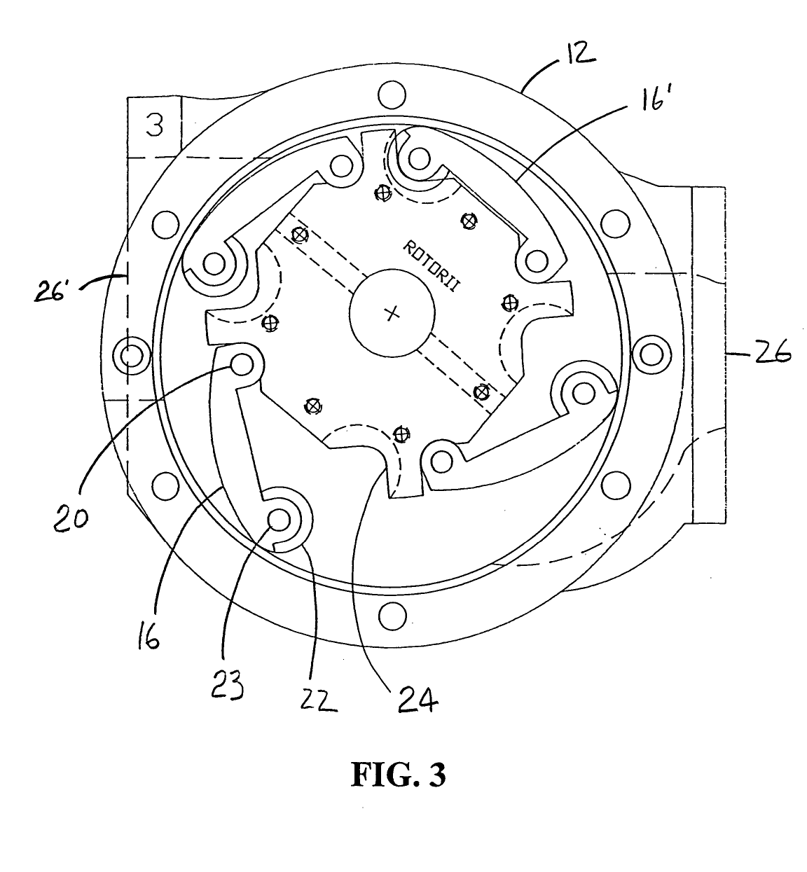

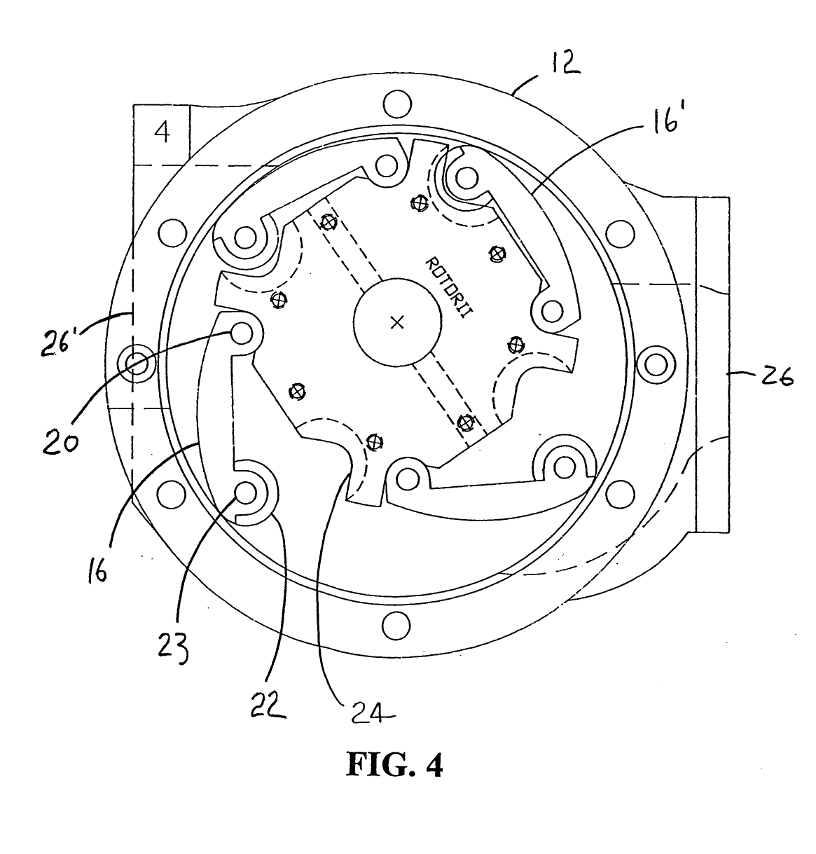

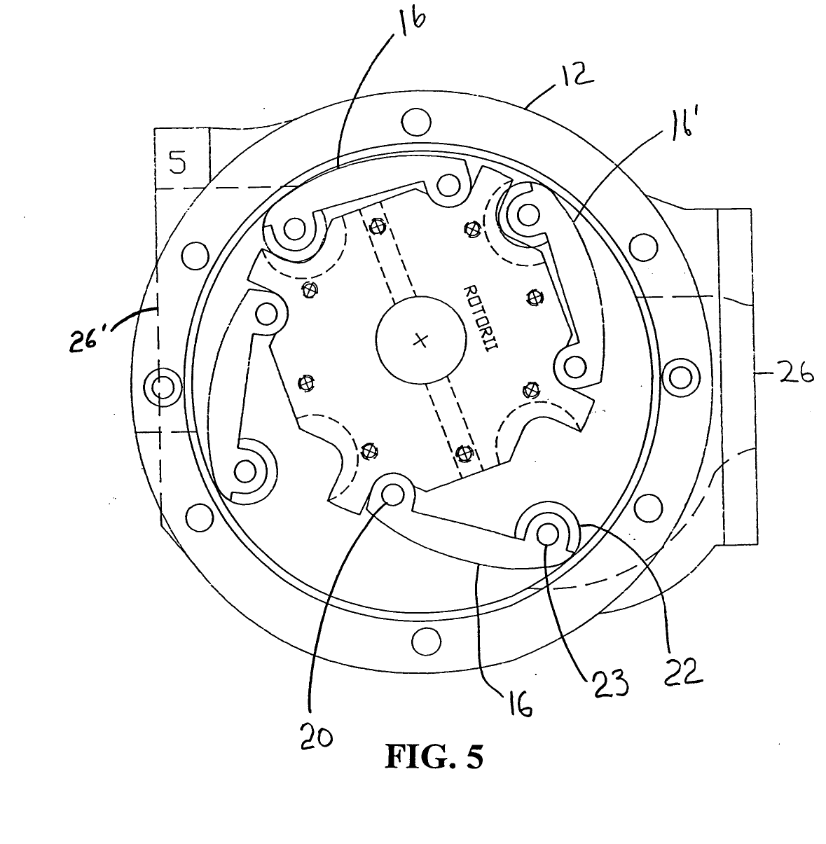

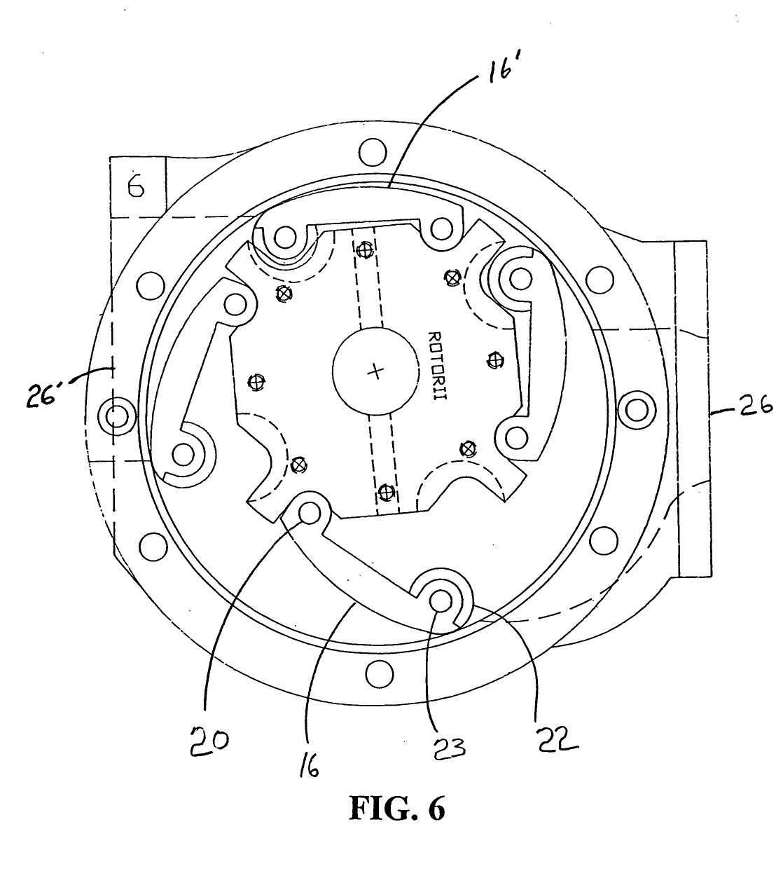

Referring now to FIGS. 1-6, wherein the reference numerals refer to the identical features across all of the figures, shown in the figures is a pump 10 comprising a housing 12 defining a substantially cylindrical internal chamber 14. While a cylindrical internal chamber is preferred, the internal chamber may also be elliptical, spherical, semi-hemispherical, and the like. Eccentrically disposed within the chamber 14 is a rotor 18 having pivotally attached thereto a plurality of vanes 16. As shown in FIGS. 1-6, the pump includes four vanes. The pump must include at least two vanes, and can include more than four vanes. However, the preferred number of vanes is four.

Each vane 16 includes a first end 15 and a second end 17 (see FIG. 1). The first end of each vane 16 is pivotally attached to the rotor via a connector, such as a hinge or pin 20. Any connector or fastener dimensioned and configured to pivotally connect the vane to the rotor will suffice, so long as the vane pivots freely. The pin 20 allows each vane to move between a retracted position, as shown by the vane designated 16′ in each of FIGS. 1-6, and an extended position, as evidenced by the other vanes in the figures.

At the second end of each vane is one or more friction reducers, such as bushings or bearings 22. As shown in the figures, the bearings 22 are mounted to the second end of each vane via a connector, such as mounting pin 23. Any type of connector or fastener for connecting the bearings to the second end of the vanes will suffice, so long as the bearings are held in place and can rotate freely. As shown in the figures, the mounting pin 23 allows its corresponding bearing to rotate (or glide in the case of a bushing) along the inner surface of the housing 12. In practice, the pump 10 of the present invention rotates in a clockwise direction when viewed as in FIGS. 1-6.

The bearings 22 are dimensioned and configured to provide an extremely small gap of approximately 1 to 10 mils (approximately 0.0025 mm to 0.25 mm) between the second end 17 of each vane and the walls of the chamber 14. In short, it is the bearings 22 that make contact with the chamber wall, not the second ends of each vane.

When the vanes are in the retracted position (at the 12 o'clock position in each of FIGS. 1-6), the bearings 24 preferably rest with a corresponding and complementary pocket 24 (see FIG. 1) defined within the rotor 18.

Because it is the bearings 22 that contact the chamber wall, and not the second end of each vane, the pump of the present invention can operate without lubrication. The bearings 22 provide sufficiently low friction to allow the rotor to turn at operational speeds without the need for a lubricating film to be present between the second end 17 of each vane and the wall of the chamber 14. Of course, lubrication can be introduced into the pump, but it is not required.

As shown in FIGS. 1-6, the housing 12 includes an intake manifold 26 shown in broken lines and an exhaust manifold 26′ (also shown in broken lines). As depicted in FIGS. 1-6, the rotor turns clockwise. Thus, as the rotor 18 turns, the vanes move from their retracted position, at the 12 o'clock position in FIGS. 1-6, to their extended position, at the 6 o'clock position of FIGS. 1-6. In the process, the second end 17 of each vane 16 sweeps past the intake manifold 26 at the 3 o'clock position. This draws air from outside the chamber to inside the chamber. As the rotor continues to turn, each vane moves from the extended position back to the retracted position, at the same time sweeping past exhaust manifold 26′, at the 9 o'clock position in FIGS. 1-6. Thus, when the rotor makes a full 360° rotation, each vane passes through its fully extended position and its fully retracted position. In the process air is drawn into the chamber 14 through the intake manifold 26, compressed, and forced out of the exhaust manifold 26′.

In the preferred embodiment, the vanes are not spring-loaded in any fashion. Rather, the vanes are extended by simple centrifugal force.

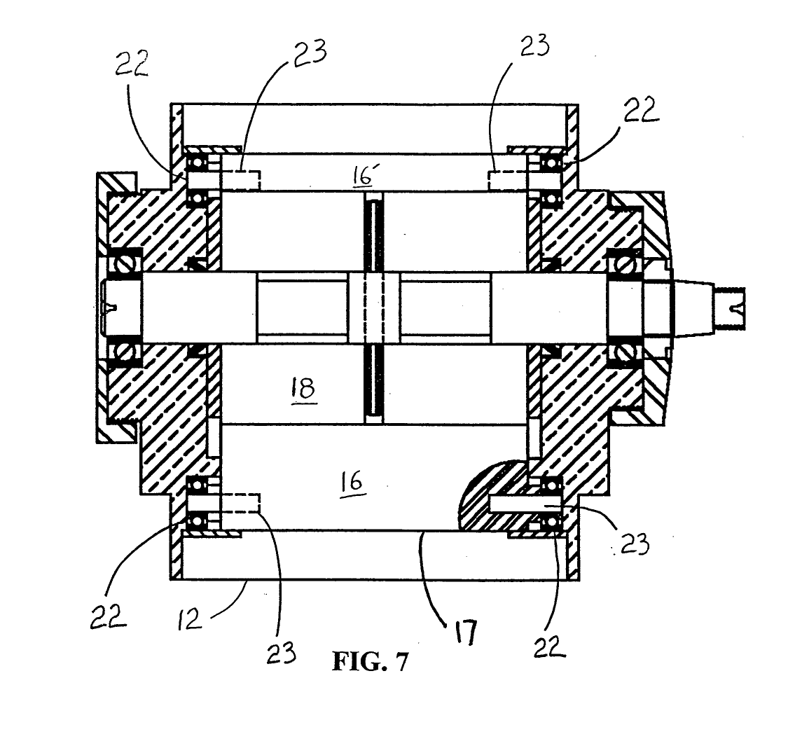

Alternatively, the second end 17 of each vane 16 can be forced to track the wall of the chamber by defining a concentric bearing race 30 into the wall of the chamber and dimensioning and configuring the bearings 22 to engage the concentric bearing race. See FIGS. 7-10.

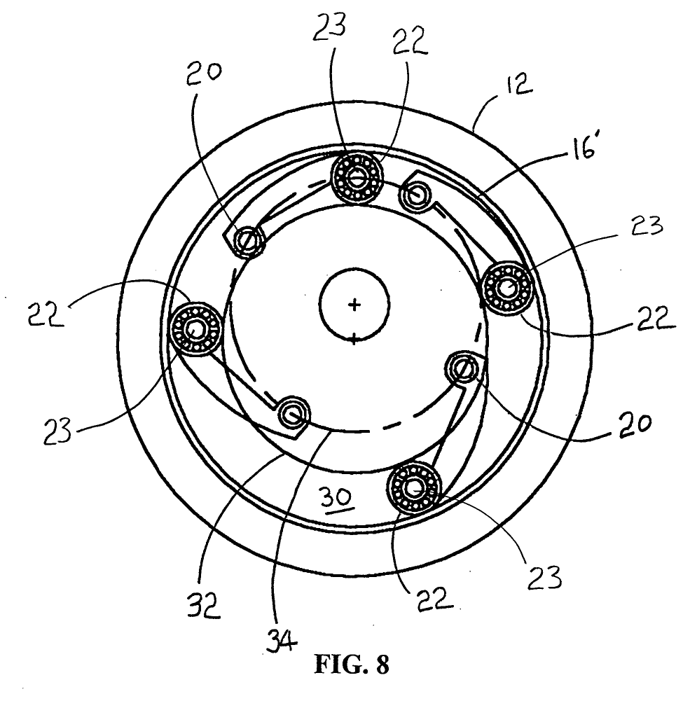

FIG. 7 is a longitudinal cross-section of a pump having such a concentric bearing race. As shown in FIG. 7, each bearing 22 is mounted to the second end 17 of each vane (vane 16 in the extended position, vane 16′ in the retracted position) via an elongated pin 23. The bearings rest within the concentric bearing race 30, which is best illustrated in FIG. 8 (a transverse cross-section of the pump with the details of the rotor removed). As shown in FIGS. 7 and 8, the rotor 18 is eccentrically disposed within the chamber, but the bearing race 30 is defined concentrically within the wall of the chamber. The path followed by the first end of each vane is thus eccentric with respect to the chamber, as shown by the broken line 34 in FIG. 8, while the path followed by the second end of each vane is concentric with respect to the chamber, as shown by the solid line 32 in FIG. 8.

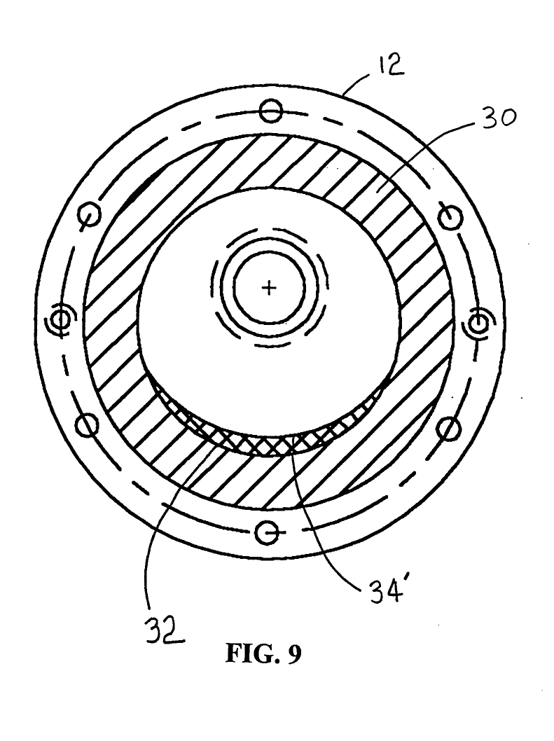

Note that these two paths are followed in both the first and second embodiments of the invention. The difference is that in the second embodiment of the invention, the concentric bearing race 30 forces each vane to move from the retracted position to the extended position, regardless of the speed at which the rotor is turned. In short, in the second embodiment, the motion of each vane is constrained by the mating engagement of the bearing 22 within the concentric race 30. In the first embodiment, in contrast, the motion of the vane from the retracted position to the extended position is caused by the centrifugal force generated when the rotor is turned. FIG. 9, which is another transverse cross-sectional view of the pump, depicts the concentric bearing race 30 (in diagonal hatching), and the concentric path 32 followed by the second end of each vane. The line 34′ depicts a portion of the eccentric path 34 (see FIG. 8) followed by the first end of each vane. The cross-hatched area in FIG. 9 thus depicts area defined by the boundary between the eccentric path 34 followed by the first end of each vane, and the concentric bearing race 32 that defines the path followed by the second end of each vane.

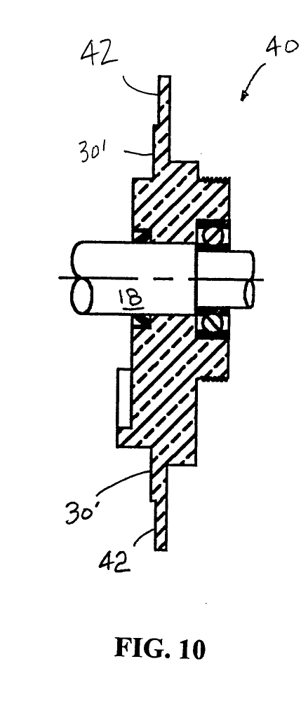

FIG. 10 illustrates a longitudinal cross-section an end plate 40 having concentric shoulder 30′ and flange 42, along with the rotor 18 passing therethrough. The end plate fits onto the housing of the pump and is bolted thereto through the flange 42. The shoulder 30′ in conjunction with the wall of the chamber 14 (see FIG. 1) defines the concentric bearing race 30 depicted in FIG. 8.

It is preferred that the housing 12, rotor 18, and vanes 16 be fabricated from aluminum, although any suitable metal or alloy (various steels, titanium, iron, etc.) or engineering plastic will function with comparable results. The bearings/bushings 22 can be made of highly polished metal, or low-friction polymers, such as hexamethylene diamine (e.g., NYLON-type polymers), or polytetrafluorethylene (e.g., TEFLON-type polymers).

The intended use for the present invention is as a supercharger for internal combustion engines. However, the pump described herein will function as a vacuum pump for any application where a vacuum pump is required. The pump described herein will also function to move non-compressible liquids such as water and the like.

1. A rotary pump comprising:
a housing defining an internal chamber, the internal chamber having a peripheral wall;
a rotor eccentrically positioned within the internal chamber;
at least two vanes, each vane having a first end and a second end, wherein the first end of each vane is pivotally mounted to the rotor, and wherein each vane is movable between a retracted position and an extended position; and
at least one friction reducer attached to the second end of each vane, wherein the friction reducer is dimensioned and configured to: (a) contact the peripheral wall of the internal chamber when its corresponding vane is in the extended position, and (b) to prevent the second end of its corresponding vane from contacting the peripheral wall when the corresponding vane is in the extended position.

2. The rotary pump of claim 1, wherein the rotor defines a corresponding complementary pocket for each friction reducer, wherein each complementary pocket is positioned within the rotor such that its corresponding friction reducer rests within the corresponding complementary pocket when the vane to which the friction reducer is attached is in the retracted position.

3. The rotary pump of claim 1, comprising four vanes.

4. The rotary pump of claim 1, wherein the friction reducer is a bearing.

5. The rotary pump of claim 1, wherein the friction reduce is a bushing.

6. The rotary pump of claim 1, wherein when each vane is in the extended position, a gap of from about 1 mil to about 10 mils (about 0.0025 mm to about 0.25 mm) is defined between the second end of each vane and the peripheral wall of the internal chamber.

7. The rotary pump of claim 1, further comprising a bearing race defined concentrically within, and with respect to, the peripheral wall of the internal chamber, and wherein each friction reducer is dimensioned and configured to engage and to travel within the bearing race.

8. The rotary pump of claim 7, wherein each friction reducer is attached to the second end of its corresponding vane via an elongated pin extending from an edge of the vane.

9. The rotary pump of claim 7, wherein the rotor defines a corresponding complementary pocket for each friction reducer, wherein each complementary pocket is positioned within the rotor such that its corresponding friction reducer rests within the corresponding complementary pocket when the vane to which the friction reducer is attached is in the retracted position.

10. The rotary pump of claim 7, comprising four vanes.

11. The rotary pump of claim 7, wherein the friction reducer is a bearing.

12. The rotary pump of claim 7, wherein the friction reduce is a bushing.

13. The rotary pump of claim 7, wherein when each vane is in the extended position, a gap of from about 1 mil to about 10 mils (about 0.0025 mm to about 0.25 mm) is defined between the second end of each vane and the peripheral wall of the internal chamber.

14. A rotary pump comprising:
a housing defining an internal chamber, the internal chamber having a peripheral wall;
a bearing race defined concentrically within, and with respect to, the peripheral wall of the internal chamber;
a rotor eccentrically positioned within the internal chamber;
at least two vanes, each vane having a first end and a second end, wherein the first end of each vane is pivotally mounted to the rotor, and wherein each vane is movable between a retracted position and an extended position; and
at least one friction reducer attached to the second end of each vane, wherein the friction reducer is dimensioned and configured to: (a) contact the peripheral wall of the internal chamber when its corresponding vane is in the extended position, and (b) to prevent the second end of its corresponding vane from contacting the peripheral wall when the corresponding vane is in the extended position, and further wherein each friction reducer is dimensioned and configured to engage and to travel within the bearing race.

15. The rotary pump of claim 14, wherein the rotor defines a corresponding complementary pocket for each friction reducer, wherein each complementary pocket is positioned within the rotor such that its corresponding friction reducer rests within the corresponding complementary pocket when the vane to which the friction reducer is attached is in the retracted position.

16. The rotary pump of claim 14, comprising four vanes.

17. The rotary pump of claim 14, wherein the friction reducer is a bearing.

18. The rotary pump of claim 14, wherein the friction reduce is a bushing.

19. The rotary pump of claim 14, wherein when each vane is in the extended position, a gap of from about 1 mil to about 10 mils (about 0.0025 mm to about 0.25 mm) is defined between the second end of each vane and the peripheral wall of the internal chamber.

20. A rotary pump comprising:
a housing defining an internal chamber, the internal chamber having a peripheral wall;
a bearing race defined concentrically within, and with respect to, the peripheral wall of the internal chamber;
a rotor eccentrically positioned within the internal chamber;
four vanes, each vane having a first end and a second end, wherein the first end of each vane is pivotally mounted to the rotor, and wherein each vane is movable between a retracted position and an extended position;
at least one friction reducer attached to the second end of each vane, wherein the friction reducer is dimensioned and configured to: (a) contact the peripheral wall of the internal chamber when its corresponding vane is in the extended position, and (b) to prevent the second end of its corresponding vane from contacting the peripheral wall when the corresponding vane is in the extended position, and further wherein each friction reducer is dimensioned and configured to engage and to travel within the bearing race; and
wherein when each vane is in the extended position, a gap of from about 1 mil to about 10 mils (about 0.0025 mm to about 0.25 mm) is defined between the second end of each vane and the peripheral wall of the internal chamber.
